(19) United States
(12) Patent Application Publication
(10) Pub. No.: US 2010/0189368 A1
(43) Pub. Date: Jul. 29, 2010

(54) DETERMINING VIDEO OWNERSHIP WITHOUT THE USE OF FINGERPRINTING OR WATERMARKS

(75) Inventors: George T. Des Jardins, Washington, DC (US); Michael Sullivan, San Francisco, CA (US); Robert Impollonia, Cambridge, MA (US); Aaron Culich, San Francisco, CA (US)

Correspondence Address: WILMERHALE/BOSTON, 60 STATE STREET, BOSTON, MA, 02109, US

(73) Assignee: Affine Systems, Inc.

(21) Appl. No.: 12/399,278

(22) Filed: Mar. 6, 2009

Related U.S. Application Data
(60) Provisional application No. 61/146,919, filed on Jan. 23, 2009.

(51) Int. Cl. G06K 9/68; H04N 7/173; G06Q 50/00

(52) U.S. Cl. 382/218; 725/93; 705/7; 705/1.1; 705/317

(57) ABSTRACT

A system and method of determining who is the rights owner for video uses object recognition and can avoid the need for fingerprinting or watermarking. By examining the video for objects that are known to be in videos by a rights holder, ownership of the video can be established within certain confidence bounds. This process can be used to reestablish control of content that may have been released or recorded without authorization or was produced at costs points that precluded more invasive or production intensive techniques such as fingerprinting or watermarking.

### CROSS-REFERENCE TO RELATED APPLICATIONS

This application claims priority to provisional application Ser. No. 61/146,919, filed Jan. 23, 2009, which is incorporated herein by reference.

### BACKGROUND

Rights holders of video are faced with a variety of challenges. To grow audience, they often allow their content to be exposed to audiences in ways that were not anticipated in the past, and that have a variety of challenges. For example, YouTube audiences are critical to comedy shows, which may want to allow clips of their content to circulate, or news programs, which may want their news videos to have wide exposure.

One current technique for rights holders of video to use to protect their intellectual property (IP) is to use fingerprinting. With fingerprints, a video is subjected to analysis after production, and a mathematical description of the video or scenes in the video is created.

Another method for rights holders of video to protect their IP is watermarking, in which, during the production of the video, a digital watermark is introduced into the video. These techniques require that rights holders actively participate in the protection of their content.

Claiming ownership of this content that has “escaped into the wild” can be difficult if an owner must watermark each clip prior to release, or if one must fingerprint each clip after release. In the case of watermarking, production workflow or the costs of watermarking technology may preclude broad application; and in the case of fingerprinting) one is essentially acting after it is too late.

However, humans are easily able to recognize an actor, or a set or a logo in the background and understand that the content was produced by a particular rights holder, but having people review content can be expensive and time-consuming.

### SUMMARY

The systems and methods described here allow a video rights holder to recognize their videos through pattern recognition techniques. Thus, video rights holders can claim content as theirs after-the-fact and without advance steps such as fingerprinting or watermarking. For example, by recognizing a set used in a show's production, a logo on a screen, specific actors, or other recognizable features, video that has never been fingerprinted or watermarked can be detected and identified as belonging to the rights holder. This recognition approach is especially helpful for those who currently have to use technology from a digital watermarking alliance and are forced to pay for technology even though the value of the content may be uncertain.

The systems and methods described herein enable rights holders to claim ownership of their property without ever having submitted the clip for analysis or modification in advance. By scanning videos with object detectors and creating a list of objects, and then creating a mapping of objects, logos, and people to rights holders, a system can automatically establish that a video belongs to a certain rights holder. Other features and advantages will be apparent from the following description, drawings, and claims.

### BRIEF DESCRIPTION OF THE DRAWINGS

FIG. 1 is a block diagram of an example of a system described herein.

### DESCRIPTION

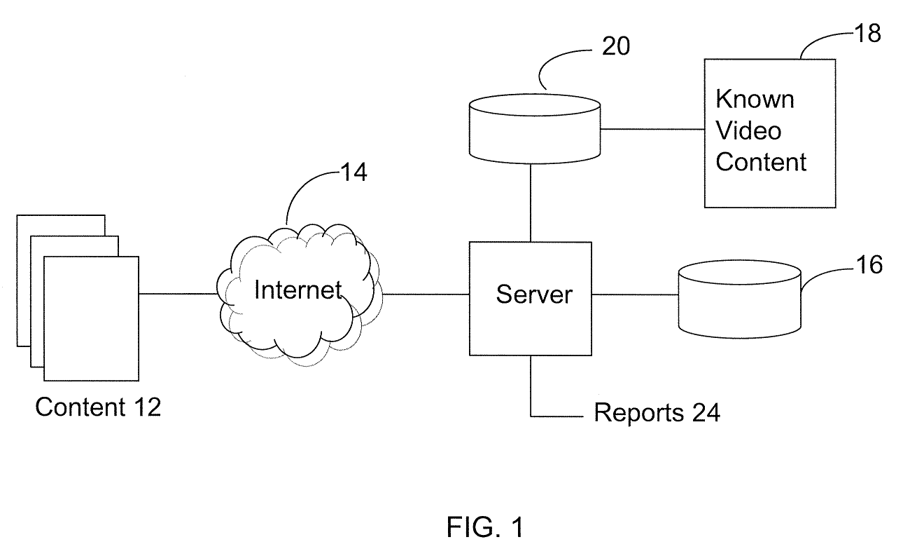

Referring to FIG. 1, a server 10 downloads video content 12 over a network 14, such as the Internet. The videos are scanned by examining all or a sample of frames that can be stored in storage 16. Previously known video content 18 was used to derive information representing known frames or portions of frames. Those known frames or portions, or mathematical representations of such frames or portions, are held in storage 20. The server can then compare regions of the frames in storage 16 to frames or mathematical representations of frames where specific regions of the frame are known to contain the object desired to be detected and stored in storage 20. After repeating this process in various areas in a frame and over numbers of frames, a list of detected objects is produced, and reports 24 can be created.

Server 10 can include a web crawling system, e.g., in a module, that can operate through an interface to access websites to obtain video content. The audio component of the video can be discarded, or it could be retained and stored if desired. While video content could be displayed in real time using the time it takes to display the content, in other embodiments, multiple screen shots from the video are captured and stored in storage. The screen shots are compared to the information representing frames or portions of frames such as a library of images or mathematical representations or images stored in storage. The processor uses pattern recognition techniques to compare the known information and new frames to identify key features. In the case of television shows, for example, the features could include logos that appear frequently on the television screen, such as on the lower left or lower portion of a screen, or could include other features such as the format of boxes of scrolling content at the bottom of the screen, or could even include pattern recognition that detects individuals or common scenes, such as the scene of a new broadcast or situation comedy. The information derived from comparisons of the pattern recognition library to the video images is then used to indicate that desired video content has been identified. This information can thus identify the video, such as what TV show it is, and can use this information to identify ownership.

A variety of processes for pattern recognition can be used to create the matching. One example is described in Viola et al., “Rapid Object Detecting Using a Boosted Cascade of Simple Features,” 2001.

When matches are found between known video content 18 and downloaded content 12, the specific video and/or ownership can be determined. This information about the specific video can be used to determine ownership. Once ownership is established, an audience size and other metrics can be determined relating to the content's consumption. For instance, by scanning videos on the Internet (such as on a website like “YouTube” that focuses on videos) for the presence of a known set of objects and matching the objects to broadcasters, and then retrieving audience data on the videos detected via this process, one can essentially create an Internet version of a ratings system (like the Nielsen TV ratings) that is potentially more objective and accurate than current methods on the Internet. One could determine ownership without identifying specific videos, e.g., by looking for how often a CNN log appears versus a Fox News logo without distinguishing specific videos.

Because the matching is not tied to a particular frame or a set of frames, this process is not fingerprinting, and therefore lacks the process and scalability issues associated with fingerprinting. Because the process does not look for digital watermarks, it does not require the additional processing step of adding the digital watermarking information. Instead this technique can be used based simply upon a known person, stage set, or other object or logo which the rights holder typically might include in a video.

The systems described above can be implemented on an appropriately programmed processor with suitable storage for programs and data, and interfaces to other components. The processor can include controllers, microprocessors, gate logic, or any other form of data processing. For example, while the system is described as using a “server,” this element and the functions implemented by it could be conducted by one or more different forms of processing, and in the same or multiple physical units. Furthermore, while the storage in FIG. 1 is shown as two different devices, the storage could be maintained on multiple devices or on a single device and in separate portions of the same memory or in different memory, and could be housed with or separately from the processing functionality.

To the extent software is used to implement the systems and methods described here, such software can be maintained as separate modules. Such software can include instructions that are executed by processing systems. The software instructions can be provided in a memory device, such as a magnetic disk, optical disk, semiconductor memory, or some other type of memory.

While human interaction can be included at various portions of this system, in some embodiments, the methods can be implemented in an automated manner without human interaction—the system can thus download videos, capture images from videos, perform a comparison to a library of known images, create a report of the results, and send the report with results, all without human input in that process.

The results can be used in a number of different ways, such as monitoring unauthorized use, tracking frequency of use for rating purposes, tracking use for royalty calculation, or otherwise for monitoring the dissemination of videos.

Other features can also be included. For example, the system can create, store, and report a probability or a confidence level for each of the matches. This level can be numerical (e.g., 90% chance) or qualitative (e.g., highly likely, somewhat likely, etc.). The probability/level can be increased by searching for multiple matches within a video. For example, with respect to a cable news program, the system could look for both the logo and for a format of information boxes and crawling information at the bottom of the video. Finding multiple features can significantly increase the confidence/probability level. The system can also capture metadata that is associated with videos and use that metadata to extract information and/or to affect a confidence index that a comparison has been made. The confidence/probability can further be increased by providing human review and also by detecting the number of times that the image appears. For example, in the case where a logo is to be detected, the logo might be more difficult to observe because of background images in some frames, but more detectable in other frames. The frequency with which the logo is found affects the confidence that the feature has been identified.

What is claimed:

1. A method for determining the rights owner of a video comprising:
downloading a video from a website;
creating from the video a set of frames or portions of frames;
comparing the images from the video with a set of known objects using pattern recognition;
determining one or more matches between the images from the video and the set of known objects; and
based on one or more determined matches, identifying the video and/or ownership of rights in the video without watermarking or fingerprinting; and
outputting information relating to the identity of such video and/or its ownership.

2. The method of claim 1, further comprising scanning a known video to create the set of known objects.

3. The method of claim 2, wherein the known objects in the set include information representing one or more of people, a production set, and/or a logo.

4. The method of claim 1, wherein the known objects include information representing one or more of people, a production set, and/or a logo.

5. The method of claim 1, further comprising deriving a confidence level for the identification of ownership and outputting an indication of such confidence level.

6. The method of claim 5, wherein the confidence level is based at least in part on identifying a plurality of identified objects.

7. The method of claim 5, wherein the confidence level is based at least in part on metadata associated with the video.

8. The method of claim 5, wherein the confidence level is based at least in part on a number of frames that have one or more matches.

9. The method of claim 1, further comprising using data derived from identifying ownership to determine an estimate of an audience for a given video.

10. The method of claim 1, further comprising using data derived from identifying ownership to determine whether royalties are due for displaying a video.

11. The method of claim 1, further comprising using data derived from identifying ownership to determine an estimate of a number of websites that have a video.

12. The methods of claim 1, wherein the acts are performed in an automated manner without necessary human interaction.

13. A system for determining the owner of rights in a video comprising:
a web interface;
storage for storing information indicating a set of known objects; and
a processor for:
for downloading a video from a website through the web interface,
creating from the video a set of still images,
comparing the images from the video using pattern recognition with the set of known objects,
determining one or more matches between the images from the video and the set of known objects, and
based on one or more determined matches, identifying ownership of rights in the video and outputting information relating to such ownership.

14. The system of claim 13, wherein the known objects include information representing one or more of people, a production set, and/or a logo.

15. The system of claim 13, further comprising deriving a confidence level for the identification of ownership and outputting an indication of such confidence level.

16. The system of claim 15, wherein the confidence level is based at least in part on identifying a plurality of identified objects.

17. The system of claim 15, wherein the confidence level is based at least in part on metadata associated with the video.

18. The system of claim 15, wherein the confidence level is based at least in part on a number of frames that have one or more matches.

19. The system of claim 15, further comprising using data derived from identifying ownership to determine an estimate of an audience for a given video.

20. The system of claim 13, further comprising using data derived from identifying ownership to determine whether royalties are due for displaying a video.

21. The system of claim 13, further comprising using data derived from identifying ownership to determine an estimate of a number of websites that have a video.

22. The systems of claim 13, wherein the acts are performed in an automated manner without necessary human interaction.
